(19) United States
(12) Patent Application Publication
(10) Pub. No.: US 2007/0059121 A1
(43) Pub. Date: Mar. 15, 2007

(54) Fastener having disengageable head

(76) Inventor: Chuan Hsia Chien, Taoyuan City (TW)

Correspondence Address: CHARLES E. BAXLEY, ESQ., 90 JOHN STREET, THIRD FLOOR, NEW YORK, NY, 10038, US

(21) Appl. No.: 11/225,463

(22) Filed: Sep. 13, 2005

(51) Int. Cl. F16B 35/06

(52) U.S. Cl. 411/396

(57) ABSTRACT

A fastener includes a shank having an outer thread and a slot formed in one end, and an anchoring member engaged into the slot of the shank. A cap includes a chamber for receiving the end of the shank and the anchoring member, to allow the shank to be coupled to the cap with the anchoring member, and to increase a coupling or a driving torque between the shank and the cap, and to allow the shank to be solidly driven by the cap. The cap is preferably made of plastic materials that may be melted, or may be made of materials having an expansion coefficient greater than that for the shank, to allow the cap to be expanded greater than that shank, and to allow the cap to be disengaged or separated from the shank when on fire.

### BACKGROUND OF THE INVENTION

1. Field of the Invention

The present invention relates to a fastener, and more particularly to a fastener having a cap or head attached to one end of a threaded shank, and disengageable or removable from the threaded shank particularly when the head and/or the threaded shank of the fastener is heated or burned.

2. Description of the Prior Art

Typical fasteners comprise a head attached to or solidly formed or provided on one end of a threaded shank, for being engaged with driving tools, which may rotate or drive the fasteners into workpieces.

For example, U.S. Pat. No. 5,746,560 to Barth et al. discloses one of the typical fasteners and also comprises a threaded shank including a head attached to or solidly formed or provided on one end thereof, for being engaged with and rotated or driven by various driving tools. The head and the threaded shank are normally made of metal materials and are solidly formed together, and may not be separated or disengaged from each other, particularly when the head and the threaded shank of the fastener are heated or burned in such as fire disasters.

U.S. Pat. No. 5,338,141 to Hulsey discloses another typical fastener also comprising a threaded shank including a head or flange attached to or solidly formed or provided on one end thereof, for being engaged with and rotated or driven by various driving tools, and a plastic cap or corrosion-resistant cap is molded or attached onto the head. The head or the flange and the threaded shank are also normally made of metal materials and are solidly formed together, and may not be separated or disengaged from each other. The cap that is made of plastic materials may be melted on fire.

However, after the plastic cap has been melted on fire, for example, the head or the flange and the threaded shank of the fastener may still be solidly formed together, and also may not be separated or disengaged from each other. For example, in some of the housings or buildings made of iron sheet plates, when on fire, the iron sheet plates may still be solidly secured together, and may not be separated or disengaged from each other, such that the fire extinguishers may not easily break through the iron sheet plates, and thus may not easily extinguish the fire.

The present invention has arisen to mitigate and/or obviate the afore-described disadvantages of the conventional fasteners.

### SUMMARY OF THE INVENTION

The primary objective of the present invention is to provide a fastener including a cap or head attached to one end of a threaded shank, and disengageable or removable from the threaded shank particularly when the head and/or the threaded shank of the fastener is heated or burned.

In accordance with one aspect of the invention, there is provided a fastener comprising a shank including an outer thread provided on an outer peripheral portion thereof, and including a slot formed in a first end thereof, an anchoring member engaged into the slot of the shank, and a cap including a chamber formed therein for receiving the first end of the shank and the anchoring member, to allow the shank to be coupled to the cap with the anchoring member, and to increase a coupling and/or a driving torque between the shank and the cap, and thus to allow the shank to be solidly driven by the cap.

The anchoring member includes a length greater than an outer diameter of the threaded shank, to allow the anchoring member to be laterally extended out of the threaded shank, and to solidly couple the threaded shank to the cap, and to increase the coupling between the threaded shank and the cap.

The anchoring member includes a bottom portion, and the cap includes a bottom portion flush with the bottom portion of the cap. The shank includes an outer peripheral recess formed therein, and the cap is engaged into the outer peripheral recess of the shank, to solidly secure the cap to the shank, and to prevent the cap from being disengaged from the shank.

The cap includes a peripheral flange extended radially and outwardly therefrom. The cap is preferably made of plastic materials that may be melted, to allow the cap to be disengaged or separated from the shank when on fire. Alternatively, the cap may be made of a material having an expansion coefficient greater than that for the shank, to allow the cap to be expanded greater than that shank, and thus to allow the cap to be disengaged or separated from the shank when on fire.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a bottom perspective view of a fastener in accordance with the present invention;

FIG. 2 is a plan schematic view of the fastener;

FIG. 3 is a cross sectional view of the fastener, taken along lines 3-3 of FIG. 1;

FIG. 4 is an exploded view of the fastener;

FIG. 5 is an enlarged partial cross sectional view of the fastener, taken along lines 5-5 of FIG. 4;

FIG. 6 is a partial cross sectional view illustrating the application of the fastener; and

FIG. 7 is a partial cross sectional view similar to FIG. 6, illustrating the operation of the fastener.

### DETAILED DESCRIPTION OF THE PREFERRED EMBODIMENT

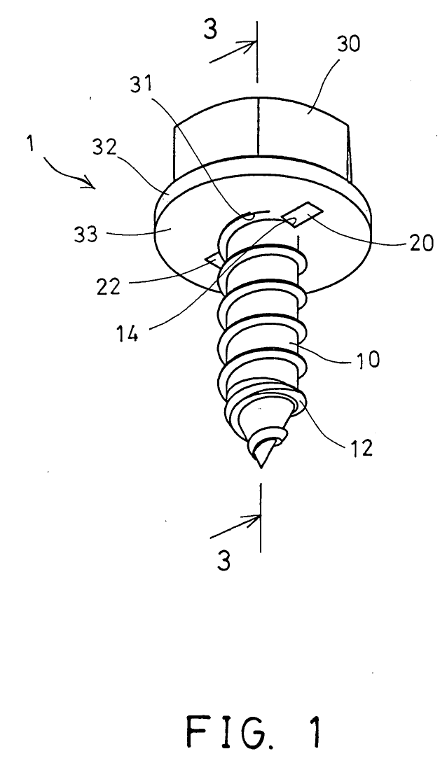

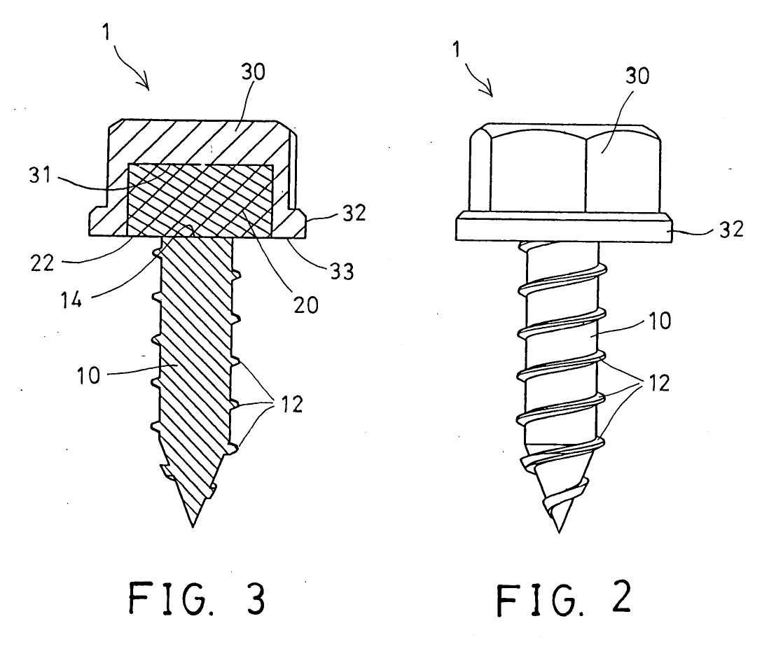

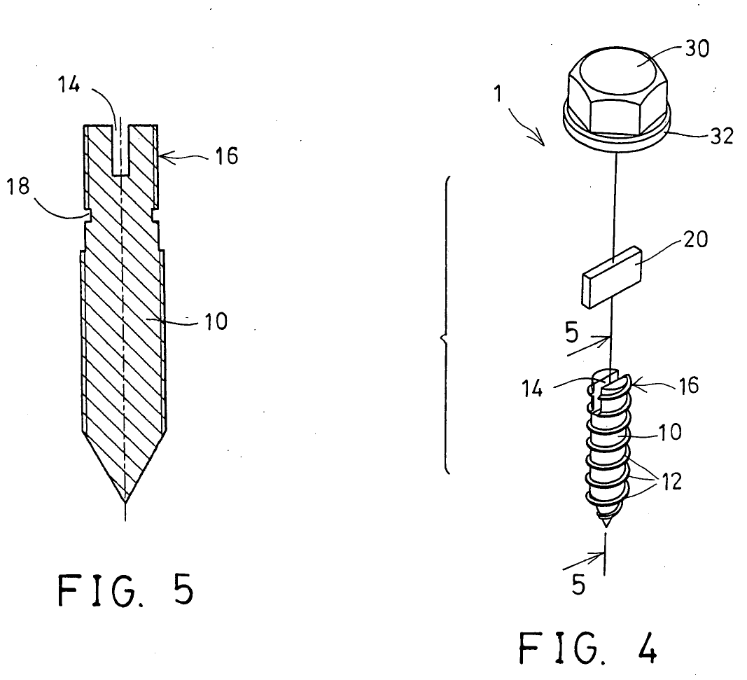

Referring to the drawings, and initially to FIGS. 1-5, a fastener 1 in accordance with the present invention may be selected from the bolt, the screw, the self-extruding screw, etc., and comprises a threaded shank 10 or a shank 10 including an outer thread or a threaded member 12 formed or provided on the outer peripheral portion thereof, and including a slot 14 formed or provided in one end, such as the upper end portion 16 thereof, for receiving an anchoring member 20 therein. It is preferable that the threaded shank 10 further includes an outer peripheral recess 18 formed in the outer peripheral portion thereof, and preferably located close to the upper end portion 16 thereof, best shown in FIG. 5.

The fastener 1 further includes a cap 30 attached or secured or molded onto the upper end portion 16 of the threaded shank 10 and the anchoring member 20, best shown in FIGS. 1 and 3. Relatively, the cap 30 includes a chamber 31 formed therein for receiving the upper end portion 16 of the threaded shank 10 and the anchoring member 20. It is preferable that the cap 30 is also molded into the outer peripheral recess 18 of the threaded shank 10, or the cap 30 is partially engaged into or has a portion engaged into the outer peripheral recess 18 of the threaded shank 10, to allow the cap 30 to be solidly anchored or secured onto the threaded shank 10, and to prevent the cap 30 from being disengaged or separated from the threaded shank 10. The cap 30 may further include a peripheral flange 32 extended radially and outwardly therefrom, for engaging with and/or for anchoring driving tools (not shown).

As best shown in FIGS. 1 and 3-4, the anchoring member 20 preferably includes a bottom surface or bottom portion 22 flush with the bottom surface or bottom portion 33 of the cap 30. The threaded shank 10 and the anchoring member 20 are preferably made of metal materials, to allow the metallic threaded shank 10 and anchoring member 20 to be easily driven or screwed into work pieces. The anchoring member 20 includes a length greater than the outer diameter of the threaded shank 10, and/or the anchoring member 20 is laterally extended out of the threaded shank 10, to solidly couple the threaded shank 10 to the cap 30, and to increase the coupling and the driving torque between the threaded shank 10 and the cap 30, and to allow the threaded shank 10 to be solidly or effectively rotated or driven by the cap 30.

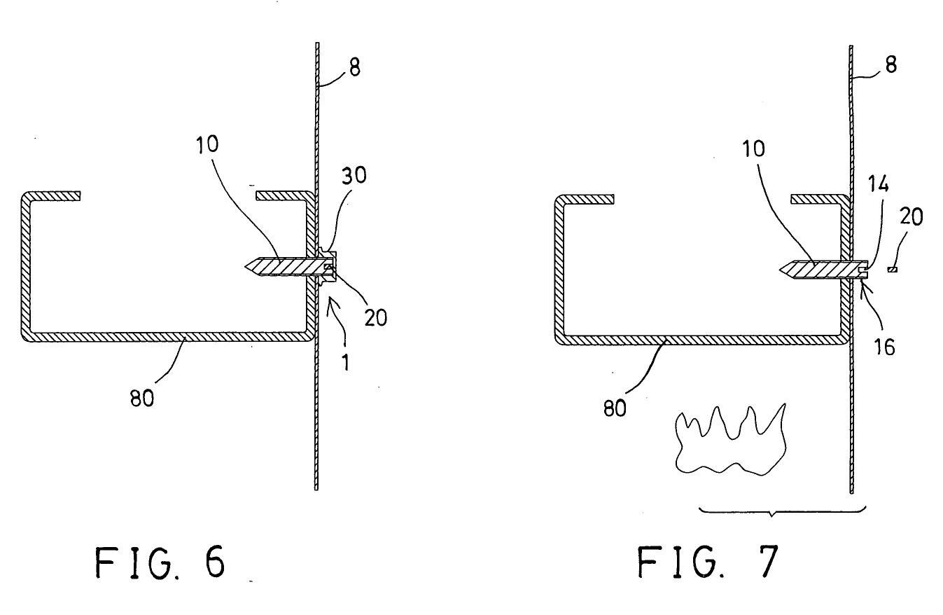

In operation, as shown in FIG. 6, the threaded shank 10 of the fastener 1 may be rotated or driven or screwed into work pieces 8, 80, such as the iron sheet plate 8 and/or the beam or rail 80, or the like, in order to solidly couple or secure the work pieces 8, 80 or the iron sheet plate 8 and the beam or rail 80 together. The cap 30 may be made of plastic materials that may be heated or melted on fire, to allow the plastic cap 30 to be disengaged from the threaded shank 10, when on fire, or when the fastener 1 is on fire or burned, as shown in FIG. 7.

The cap 30 may also be made of the materials different from that for making the threaded shank 10, such as aluminum, brass or copper, lead, zinc, etc. It is preferable that the other materials for making the cap 30 may include expansion coefficients greater than that of the materials for making the threaded shank 10, to allow the cap 30 to be expanded greater than the threaded shank 10, and thus to allow the cap 30 to be disengaged or separated from the threaded shank 10, when on fire, or when the fastener 1 is on fire or heated or burned.

Accordingly, the fastener in accordance with the present invention includes a cap or head attached to one end of a threaded shank, and disengageable or removable from the threaded shank particularly when the head and/or the threaded shank of the fastener is heated or burned.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener comprising:
a shank including an outer thread provided on an outer peripheral portion thereof, and including a slot formed in a first end thereof,
an anchoring member engaged into said slot of said shank, and
a cap including a chamber formed therein for receiving said first end of said shank and said anchoring member, to allow said shank to be coupled to said cap with said anchoring member, and to increase a coupling between said shank and said cap, and to allow said shank to be solidly driven by said cap.

2. The fastener as claimed in claim 1, wherein said anchoring member includes a length greater than an outer diameter of said threaded shank, to allow said anchoring member to be laterally extended out of said threaded shank, and to solidly couple said threaded shank to said cap, and to increase the coupling between said threaded shank and said cap.

3. The fastener as claimed in claim 1, wherein said anchoring member includes a bottom portion, and said cap includes a bottom portion flush with said bottom portion of said cap.

4. The fastener as claimed in claim 1, wherein said shank includes an outer peripheral recess formed therein, and said cap is engaged into said outer peripheral recess of said shank, to solidly secure said cap to said shank.

5. The fastener as claimed in claim 1, wherein said cap includes a peripheral flange extended radially and outwardly therefrom.

6. The fastener as claimed in claim 1, wherein said cap is made of plastic materials.

7. The fastener as claimed in claim 1, wherein said cap includes an expansion coefficient greater than that of said shank.
